(19) United States
(12) Patent Application Publication
(10) Pub. No.: US 2014/0290978 A1
(43) Pub. Date: Oct. 2, 2014

(54) INSULATION STRUCTURE OF LEAD WIRE, TRANSFORMER HAVING THE SAME, AND METHOD FOR INSULATING LEAD WIRE

(71) Applicant: MITSUBISHI ELECTRIC CORPORATION, Tokyo (JP)

(72) Inventors: Yuta Kihara, Chiyoda-ku (JP); Takayuki Fujimoto, Chiyoda-ku (JP); Kiyoyuki Ishikawa, Chiyodaku (JP); Soichiro Kainaga, Chiyoda-ku (JP); Hirotaka Muto, Chiyoda-ku (JP); Takao Tsurimoto, Chiyoda-ku (JP)

(73) Assignee: MITSUBISHI ELECTRIC CORPORATION, Chiyoda-ku, Tokyo (JP)

(21) Appl. No.: 14/351,781

(22) PCT Filed: Dec. 12, 2012
(86) PCT No.: PCT/JP2012/082182

§ 371 Date: Apr. 14, 2014

(30) Foreign Application Priority Data
Dec. 20, 2011 (JP) 2011-277773
May 28, 2012 (JP) 2012-120677

(51) Int. Cl. H01B 3/52; H01B 3/20; H01B 13/08

(52) U.S. Cl. CPC H01B 3/52; H01B 13/08; H01B 3/20
USPC 174/121 R; 156/53

(57) ABSTRACT

A lead wire for a stationary induction apparatus includes a conductor, a covering insulating layer provided on an outer periphery of the conductor, and an insulating sheet provided on the covering insulating layer. The insulating sheet includes base paper having a prescribed width, and insulating spacers disposed to protrude from the base paper at prescribed spacings in a longitudinal direction of the base paper. The insulating sheet is spirally wound continuously from a straight portion to a curved portion such that the insulating spacers come into contact with the covering insulating layer.

### TECHNICAL FIELD

The present invention relates to an insulation structure of a lead wire, a transformer having the same, and a method for insulating a lead wire.

### BACKGROUND ART

In a conventional stationary induction apparatus such as a transformer, a reactor, or the like, when a high-voltage conductor is pulled out from a coil, a lead wire pulled out from the coil is connected to a bushing terminal while ensuring electrical insulation from an iron core, a tank wall, another lead wire, and the like.

As is generally well known, there is a method for insulating a lead wire in which a conductor that is a lead wire is wound with insulating tape multiple times to ensure insulating characteristics. In this method, since the insulating tape is thin with a thickness of several hundreds of micrometers, it is necessary to wind the insulating tape multiple times to provide withstand voltage characteristics. Particularly where the stationary induction apparatus has a high insulation class, it is necessary to wind the insulating tape several tens of times.

Since this work of winding this insulating tape must be carried out within the tank of a transformer, for example, it requires time due to poor workability, which invites an increased number of days and costs of manufacturing the transformer.

Furthermore, since the thermal conductivity of the insulating tape is low, the performance of cooling a lead wire deteriorates when the above-described structure is adopted. It is therefore necessary to reduce the current density of the conductor, in order to suppress an increase in temperature of the lead wire. As a result, the diameter of the conductor must be set to be large, which invites an increase in the size of the lead wire.

Japanese Patent Laying-Open No. 63-60509 (PTD 1) is a prior art document that discloses the structure of a lead wire for an oil-immersed induction device that has achieved a size reduction. In the lead wire for an oil-immersed induction device described in PTD 1, a plurality of layers of an insulating barrier are placed concentrically with a spacer sandwiched between layers, on the exterior of insulating tape wound around a conductor.

Furthermore, of the regions surrounded with the insulating tape and the insulating barrier, those where the spacers are not present serve as a cooling medium flow path. As the spacers, a block made of pressboard or corrugated cardboard obtained by molding pressboard into waveforms is used. As the insulating barrier, pressboard formed into a cylindrical shape is used.

Japanese Utility Model Publication No. 64-47011 (PTD 2) is a prior art document that discloses a supporting structure for a lead wire that has achieved a simplified structure by reducing the number of components. The supporting structure for a lead wire described in PTD 2 supports a required portion of a lead wire for high voltage and large current, such as in a transformer, in an insulating state.

In a protective winding installed between a conductor and a supporting member in the supporting structure for a lead wire, a plurality of waveform portions are intermittently molded on prescribed sections that are set using as a reference the outside diameter of a portion that is to be provided with the protective winding of the conductor in a moldable band-shaped insulating material, and angles of inclination with respect to the width direction of peaks of adjacent waveform portions are formed to alternately face opposite directions, so as to form a single piece of waveform board tape, and the waveform board tape is wound around the conductor.

### CITATION LIST

### Patent Document

PTD 1: Japanese Patent Laying-Open No. 63-60509

PTD 2: Japanese Utility Model Publication No. 64-47011

### SUMMARY OF INVENTION

### Technical Problem

In the lead wire for an oil-immersed induction device disclosed in PTD 1, the spacers and the plate-shaped insulating barrier are combined, and therefore, where the lead wire has a curved portion, it is necessary to prepare spacers and an insulating barrier each having an individual shape conforming to the shape of this curved portion. This is accompanied by the problem of inviting an increase in the number of components and an increase in manufacturing costs.

In the supporting structure for a lead wire disclosed in PTD 2, where the band-shaped insulating material having the plurality of waveform portions intermittently molded on prescribed sections is wound around a lead wire with an outer shape that winds in a curved form, the plurality of waveform portions must be molded to conform to the curved shape. This requires the waveform board tape to be an individually designed special product, which lacks versatility.

The present invention was made in view of the aforementioned problems, and an object of the invention is to provide an insulation structure of a lead wire that has a simple structure and is versatile for lead wires having various outer shapes that wind in curved forms, a transformer having the insulation structure, and a method for insulating such a lead wire.

### Solution to Problem

The present invention is a lead wire for a stationary induction apparatus having a straight portion and a curved portion. The lead wire for a stationary induction apparatus includes a conductor, a covering insulating layer provided on an outer periphery of the conductor, and an insulating sheet provided on the covering insulating layer. The insulating sheet includes base paper having a prescribed width, and insulating spacers disposed to protrude from the base paper at prescribed spacings in a longitudinal direction of the base paper. The insulating sheet is spirally wound around the covering insulating layer continuously from the straight portion to the curved portion such that the covering insulating layer comes into contact with the insulating spacers.

An insulation structure of a lead wire based on a second aspect of the present invention includes first insulating paper wound around a surface of the lead wire, first single-face corrugated cardboard formed by affixing a liner made of third insulating paper to a central core made of second insulating paper, the first single-face corrugated cardboard being spirally wound on the first insulating paper such that the central core and the first insulating paper come into contact with each other, and fourth insulating paper spirally wound on the liner of the first single-face corrugated cardboard.

### Advantageous Effects of Invention

According to the present invention, lead wires having various curved outer shapes can be readily insulated in a versatile manner.

### BRIEF DESCRIPTION OF DRAWINGS

FIG. 1 is a perspective sketch illustrating a shell-type transformer according to a first embodiment of the present invention.

FIG. 2 is an enlarged cross-sectional view illustrating an enlarged X portion of the lead wire illustrated in FIG. 1.

FIG. 3 is a cross-sectional view seen in the direction of the arrow along line III-III illustrated in FIG. 2.

FIG. 4 is a perspective view illustrating the structure of an insulating sheet according to the first embodiment.

FIG. 5 is a schematic diagram illustrating the flow of a cooling medium according to the first embodiment.

FIG. 6 is an enlarged cross-sectional view illustrating an enlarged B portion illustrated in FIG. 2.

FIG. 7 is a perspective view illustrating the structure of an insulating sheet according to a modification of the first embodiment.

FIG. 8 is a cross-sectional view illustrating an enlarged X portion illustrated in FIG. 1 of a lead wire according to a second embodiment of the present invention.

FIG. 9 is a cross-sectional view seen in the direction of the arrow along line IX-IX illustrated in FIG. 8.

FIG. 10 is a perspective view illustrating the structure of a corrugated board sheet according to the second embodiment.

FIG. 11 is a perspective view illustrating the structure of a corrugated board sheet according to a modification of the second embodiment.

FIG. 12 is a perspective view illustrating the external appearance of an insulation structure of a lead wire according to a third embodiment of the present invention.

FIG. 13 is a cross-sectional view seen in the direction of the arrow along line XIII-XIII illustrated in FIG. 12.

FIG. 14 is a flowchart illustrating a method for insulating the lead wire according to the third embodiment of the present invention.

FIG. 15 is a perspective view illustrating a state in which first insulating paper is wound around the lead wire in the third embodiment.

FIG. 16 is a perspective view illustrating the structure of single-face corrugated cardboard according to the third embodiment.

FIG. 17 is a side view illustrating a dimensional relation when the single-face corrugated cardboard of FIG. 16 is seen in the direction of arrow XVII.

FIG. 18 is a front view illustrating a dimensional relation when the single-face corrugated cardboard of FIG. 16 is seen in the direction of arrow XVIII.

FIG. 19 is a perspective view illustrating a state in which the single-face corrugated cardboard is wound on the first insulating paper of the lead wire in the third embodiment.

FIG. 20 is a perspective view illustrating a state in which fourth insulating paper is wound on a liner of the single-face corrugated cardboard in the third embodiment.

FIG. 21 is a cross-sectional view illustrating the structure of an insulation structure of a lead wire according to a fourth embodiment of the present invention.

FIG. 22 is a flowchart illustrating a method for insulating the lead wire according to the fourth embodiment of the present invention.

### DESCRIPTION OF EMBODIMENTS

With reference to the drawings, a lead wire for a stationary induction apparatus, an insulation structure of a lead wire, a transformer having them, and a method for insulating a lead wire according to embodiments of the present invention will be described hereinafter. In the description of the following embodiments, the same or corresponding parts in the figures are indicated by the same reference characters, and the description thereof will not be repeated.

### First Embodiment

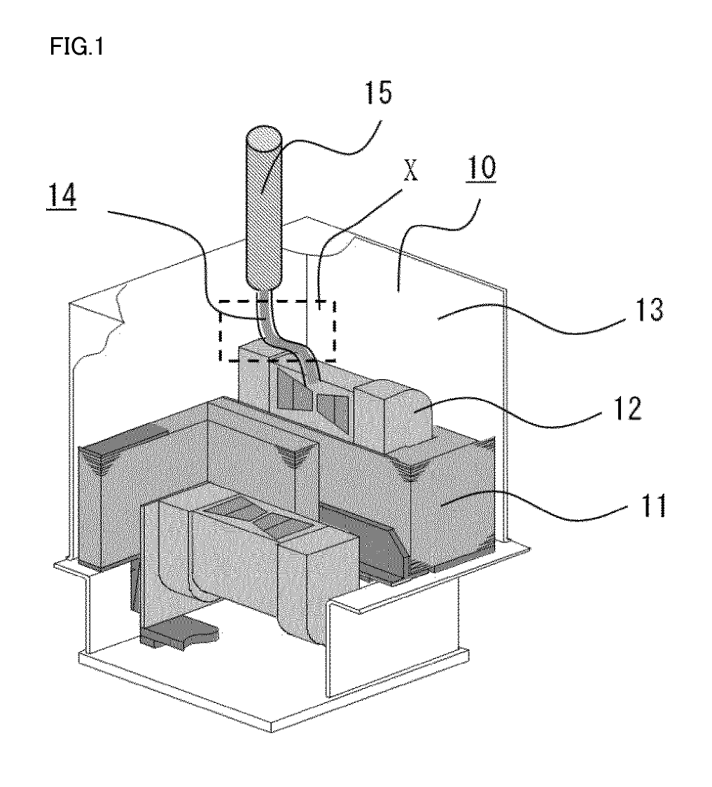

FIG. 1 is a perspective view of a shell-type transformer, which is a stationary induction apparatus according to a first embodiment of the present invention. In FIG. 1, a part of the structure is viewed in cross section.

As illustrated in FIG. 1, shell-type transformer 10 that is a stationary induction apparatus according to this embodiment has an iron core 11, a coil 12, and a tank 13. The inside of tank 13 is filled with a cooling medium (not illustrated) such as oil, for example.

Iron core 11 and coil 12 are housed within tank 13. A lead wire 14 is pulled out from coil 12. Lead wire 14 is connected to a terminal on a lower end of bushing 15 while providing insulation from iron core 11, tank 13, and other leads (not illustrated).

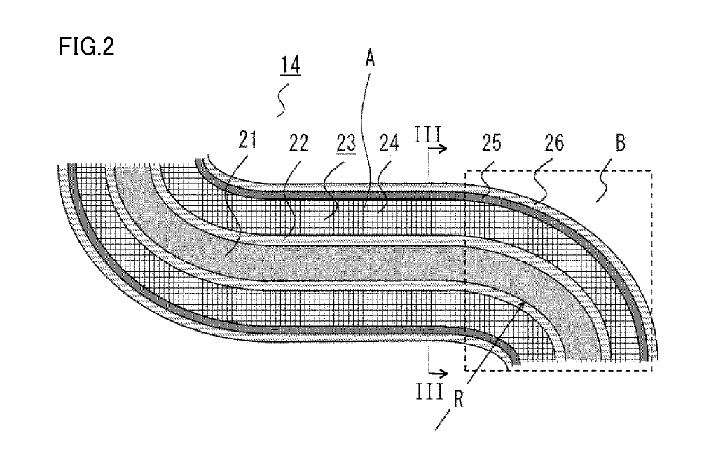

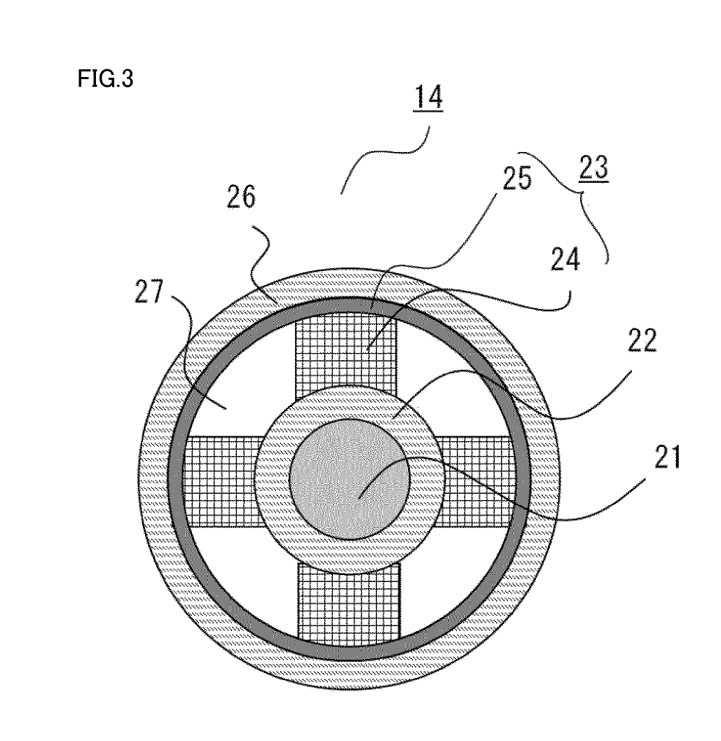

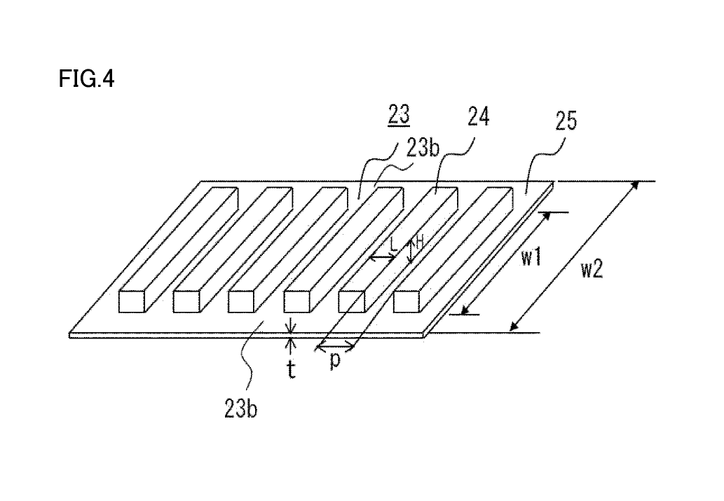

FIG. 2 is an enlarged cross-sectional view illustrating an enlarged X portion of the lead wire illustrated in FIG. 1. FIG. 3 is a cross-sectional view seen in the direction of the arrow along line III-III illustrated in FIG. 2. FIG. 4 is a perspective view illustrating the structure of an insulating sheet according to the first embodiment.

As illustrated in FIG. 2, owing to a restriction due to the structure of shell-type transformer 10, a straight portion A and a curved portion B are present in lead wire 14. Curved portion B has a conductor curvature R of roughly about 200 mm to 700 mm, though it varies depending on the capacity and the like of shell-type transformer 10. A conductor 21 has a diameter of 15 mm to 35 mm. While conductor 21 has a circular cross-sectional shape as illustrated in FIG. 3, the cross-sectional shape of conductor 21 may not necessarily be circular, and may be a cross section having no acute corners, for example, a rectangle.

As illustrated in FIG. 2, in lead wire 14, insulating tape 22 serving as a covering insulating layer is wound around an exterior of conductor 12, continuously from straight portion A to curved portion B. Insulating sheet 23 is spirally wound around an exterior of insulating tape 22, continuously and seamlessly from straight portion A to curved portion B.

As illustrated in FIG. 4, insulating sheet 23 is formed by affixing a plurality of insulating spacers 24 to a surface of base paper 25 to protrude from base paper 25, at prescribed formation intervals p in a longitudinal direction of base paper 25.

In this embodiment, base paper 25 is formed of pressboard and has a thickness t of 0.8 mm. Thickness t of base paper is set in consideration of a width w2 of base paper 25, as well as the workability of winding with the diameter of conductor 21 described above. Width w2 is about 20 mm to 30 mm, for example.

Insulating spacer 24 made of pressboard has a width w1 not greater than width w2 of base paper 25, about 10 mm to 20 mm, for example. In this embodiment, while insulating spacer 24 has a rectangular cross-sectional shape, the cross-sectional shape of insulating spacer 24 is not limited thereto, and may be a semicircle or a trapezoid. Material of insulating spacer 24 is not limited to pressboard, and may be any insulating material that is inexpensive and easy to mold. Formation interval p, length L, and height H of insulating spacer 24 are selected as appropriate, in accordance with the diameter of conductor 21, the capacity of shell-type transformer 10, and the like.

As illustrated in FIG. 3, when winding insulating sheet 23 on insulating tape 22, insulating sheet 23 is disposed such that insulating spacers 24 come into contact with a surface of insulating tape 22. Insulating tape 26 is then thinly wound around an outer periphery of insulating sheet 23.

Of regions surrounded with insulating tape 22 and base paper 25, regions where insulating spacers 24 are not positioned serve as a flow path 27 for the cooling medium. In this embodiment, a single layer of a combined structure of insulating tape 26 and insulating sheet 23 is formed; however, this combined structure is repeatedly formed as required, in terms of insulation design.

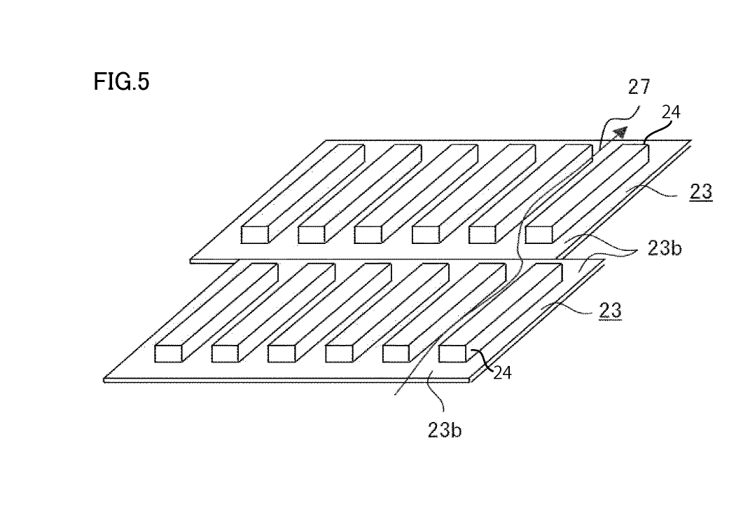

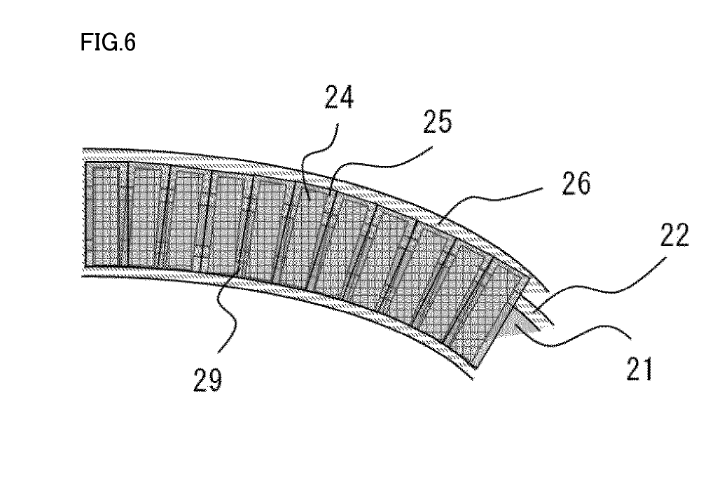

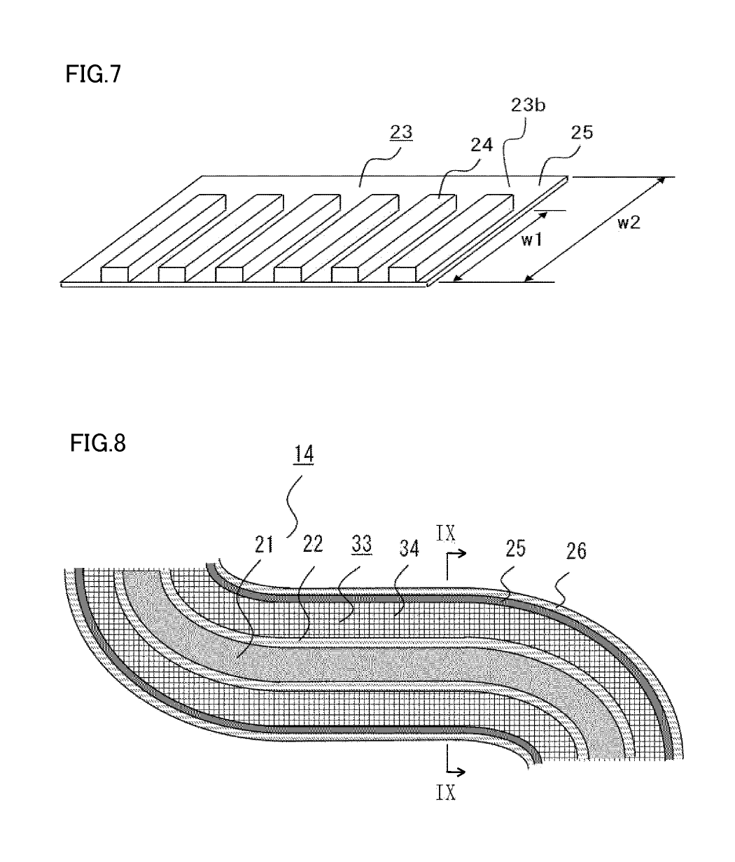

FIG. 5 is a schematic diagram illustrating the flow of the cooling medium according to the first embodiment. FIG. 6 is an enlarged cross-sectional view illustrating an enlarged B portion illustrated in FIG. 2. FIG. 7 is a perspective view illustrating the structure of an insulating sheet according to a modification of the first embodiment.

Width w1 of insulating spacer 24 and width w2 of base paper 25 forming insulating sheet 23 may be the same or different. Where width w1 of insulating spacer 24 and width w2 of base paper 25 are different, an edge portion 23b is formed as illustrated in FIG. 4.

When width w2 of base paper 25 is greater than width w1 of insulating spacer 24, as illustrated in FIG. 5, even if the positions of respective insulating spacers 24 on layers of insulating sheet 23 adjacent to each other are displaced in the state where insulating sheet 23 is spirally wound, this displacement is unlikely to hinder the flow of the cooling medium owing to the presence of edge portion 23b. The cooling performance for lead wire 14 can thus be improved.

Furthermore, when width w2 of base paper 25 is greater than width w1 of insulating spacer 24, at the time of winding insulating sheet 23 in curved portion B, edge portions 23b of base paper 25 where insulating spacers 24 are not provided can be placed over each other at adjacent circumferential sites of layers of insulating sheet 23 to form an overlap portion 29.

Since the edges in a width direction of layers of base paper 25 that are spirally wound and adjacent to each other are overlapped with each other, conductor 21 wound with insulating tape 22 can be covered with insulating sheet 23 without any clearance.

It is noted that a clearance may be present between layers of insulating sheet 23 adjacent to each other on an exterior of curved portion B. In this case, even if the insulation performance for lead wire 14 may deteriorate, the cooling medium can flow through this clearance, which may improve the cooling performance for lead wire 14.

In this embodiment, as illustrated in FIG. 4, base paper 25 protrudes from both sides of each insulating spacer 24 in the width direction of base paper 25; however, as in the modification illustrated in FIG. 7, base paper 25 may protrude from only one side of each insulating spacer 24 in the width direction of base paper 25.

In shell-type transformer 10 according to this embodiment, insulation can be formed with the combination of insulating tape 22 and insulating sheet 23, also for lead wire 14 having curved portion B as with a lead wire having straight portion A only. An increase in the number of components can therefore be prevented, and the workability during manufacture of lead insulation can be improved. Furthermore, of the regions surrounded with insulating tape 22 and base paper 25, regions where insulating spacers 24 are not positioned function as flow path 27 for the cooling medium, and therefore, high cooling performance can be achieved in lead wire 14.

### Second Embodiment

In the first embodiment, insulating sheet 23 formed by affixing the plurality of insulating spacers 24 onto base paper 25 is wound around the perimeter of insulating tape 22; however, a corrugated board sheet formed by affixing corrugated board onto base paper may also be wound as the insulating sheet. A lead wire for a stationary induction apparatus according to a second embodiment of the present invention uses a corrugated board sheet.

FIG. 8 is a cross-sectional view illustrating the enlarged X portion shown in FIG. 1 of the lead wire according to the second embodiment of the present invention. FIG. 9 is a cross-sectional view seen in the direction of the arrow along line IX-IX illustrated in FIG. 8.

As illustrated in FIGS. 8 and 9, in this embodiment, insulating tape 22 as the covering insulating layer is wound around the exterior of conductor 21. A corrugated board sheet 33 formed by affixing corrugated board 34 to a surface of base paper 25 is spirally wound around the exterior of insulating tape 22. Corrugated board sheet 33 is wound such that corrugated board 34 comes into contact with a surface of insulating tape 22.

Insulating tape 26 is thinly wound around an outer periphery of corrugated board sheet 33. A region between corrugated board 34 and insulating tape 22 and a region between corrugated board 34 and base paper 25 serve as flow path 27 for a cooling medium.

In this embodiment, a single layer of a combined structure of insulating tape 26 and corrugated board sheet 33 is formed; however, this combined structure is repeatedly formed as required, in terms of insulation design.

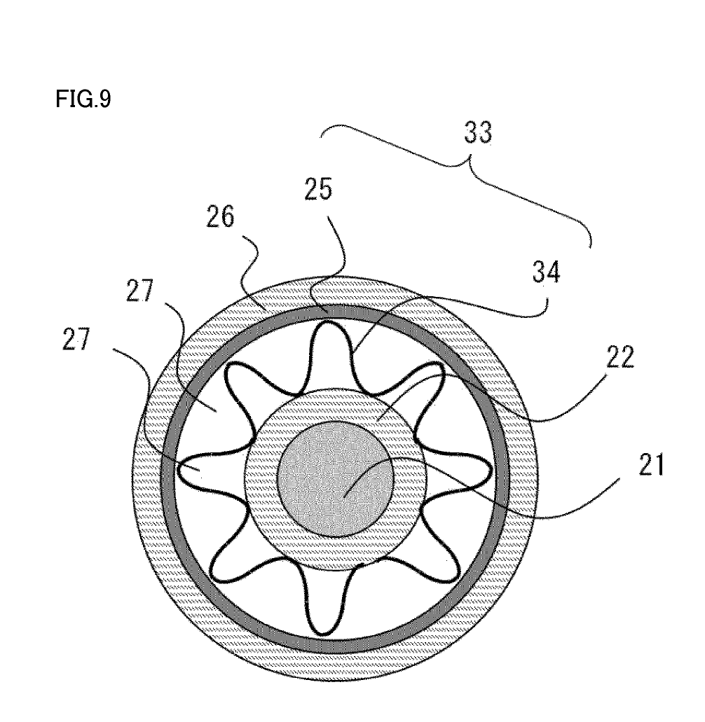

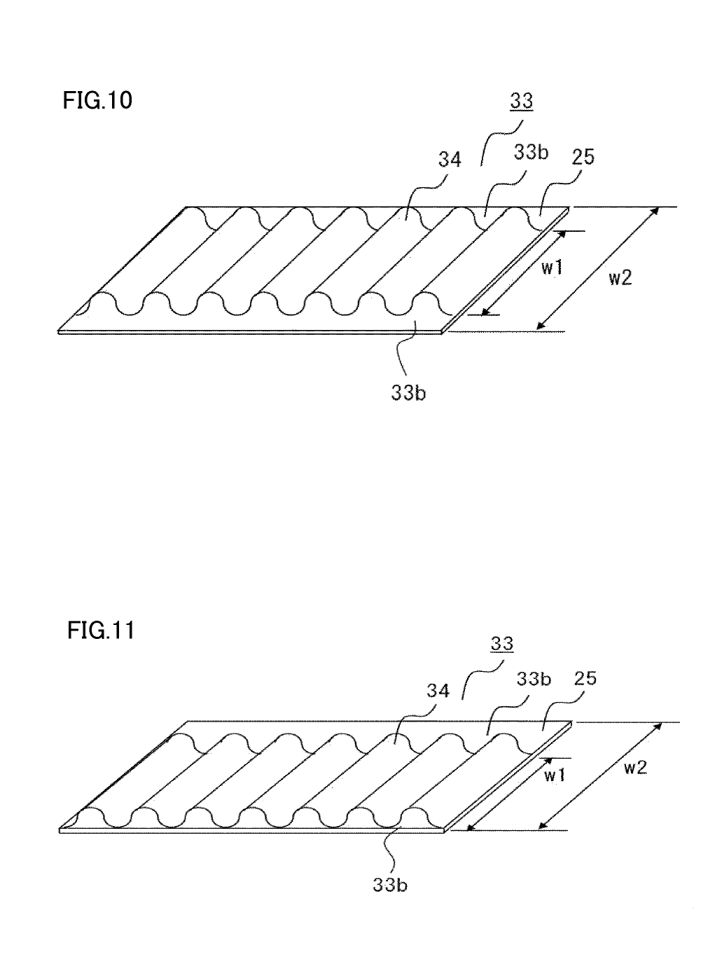

FIG. 10 is a perspective view illustrating the structure of the corrugated board sheet according to this embodiment. FIG. 11 is a perspective view illustrating the structure of a corrugated board sheet according to a modification of this embodiment.

A width w1 of corrugated board 34 and a width w2 of base paper 25 forming corrugated board sheet 33 may be the same or different. When width w1 of corrugated board 34 and width w2 of base paper 25 are different, an edge portion 33b is formed as illustrated in FIG. 10.

When width w2 of base paper 25 is greater than width w1 of corrugated board 34, as illustrated in FIG. 8, even if the positions of respective peaks of corrugated board 34 on layers of corrugated board sheet 33 adjacent to each other are displaced in the state where corrugated board sheet 33 is spirally wound, this displacement is unlikely to hinder the flow of the cooling medium owing to the presence of layers of edge portion 33b. The cooling performance for lead wire 14 can thus be improved.

Moreover, when width w2 of base paper 25 is greater than width w1 of corrugated board 34, at the time of winding corrugated board sheet 33 in curved portion B, edge portions 33b of base paper 25 where corrugated board 34 is not provided can be placed over each other at adjacent circumferential sites of corrugated board sheet 33 to form an overlap portion.

Since the edge portions in a width direction of layers of base paper 25 that are spirally wound and adjacent to each other are overlapped with each other, conductor 21 wound with insulating tape 22 can be covered with corrugated board sheet 33 without any clearance.

It is noted that a clearance may be present between layers of corrugated board sheet 33 adjacent to each other on the exterior of curved portion B. In this case, even if the insulation performance for lead wire 14 may deteriorate, the cooling medium can flow through this clearance, which may improve the cooling performance for lead wire 14.

In this embodiment, as illustrated in FIG. 10, base paper 25 protrudes from both sides of corrugated board sheet 34 in the width direction of base paper 25; however, as in the modification illustrated in FIG. 11, base paper 25 may protrude from only one side of corrugated board sheet 34 in the width direction of base paper 25.

In shell-type transformer 10 according to this embodiment, insulation can be formed with the combination of insulating tape 22 and corrugated board sheet 33, also for lead wire 14 having curved portion B as with a lead wire having straight portion A only. An increase in the number of components can therefore be prevented, and the workability during manufacture of lead insulation can be improved. Furthermore, of the regions surrounded with insulating tape 22 and base paper 25, those where corrugated board 34 is not positioned function as flow path 27 for the cooling medium, and therefore, high cooling performance can be achieved in lead wire 14.

### Third Embodiment

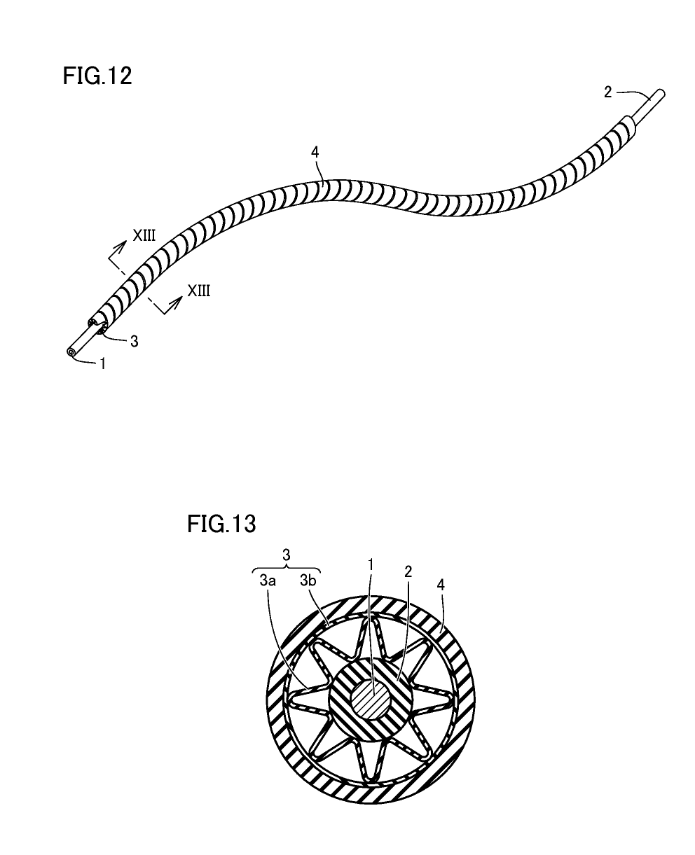

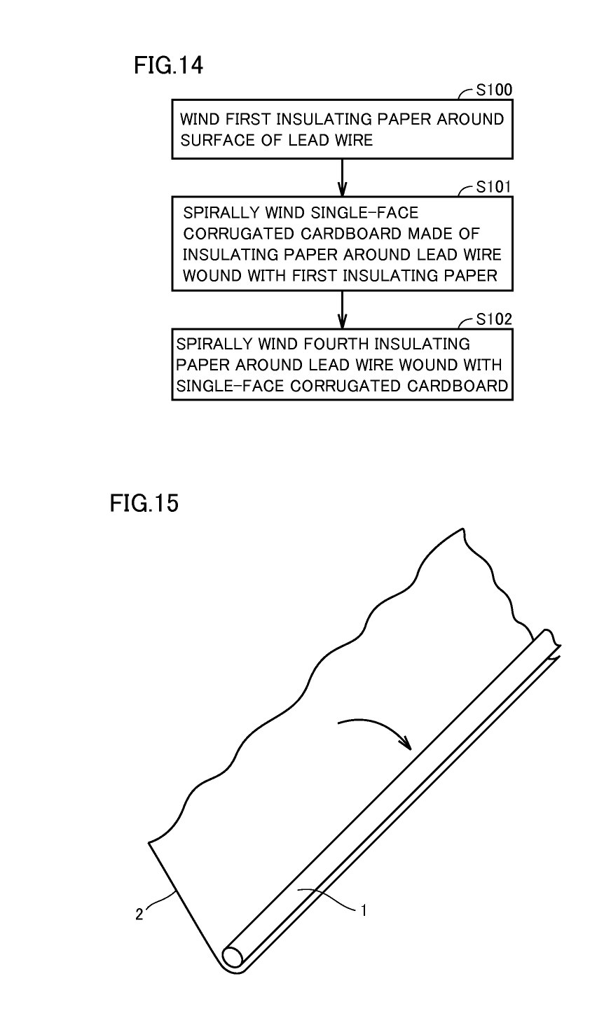

FIG. 12 is a perspective view illustrating the external appearance of an insulation structure of a lead wire according to a third embodiment of the present invention. FIG. 13 is a cross-sectional view seen in the direction of the arrow along line XIII-XIII illustrated in FIG. 12. FIG. 14 is a flowchart illustrating a method for insulating the lead wire according to the third embodiment of the present invention. FIG. 15 is a perspective view illustrating a state in which first insulating paper is wound around the lead wire in this embodiment. It is noted that FIG. 13 illustrates an actual shape in simplified form, for easy understanding.

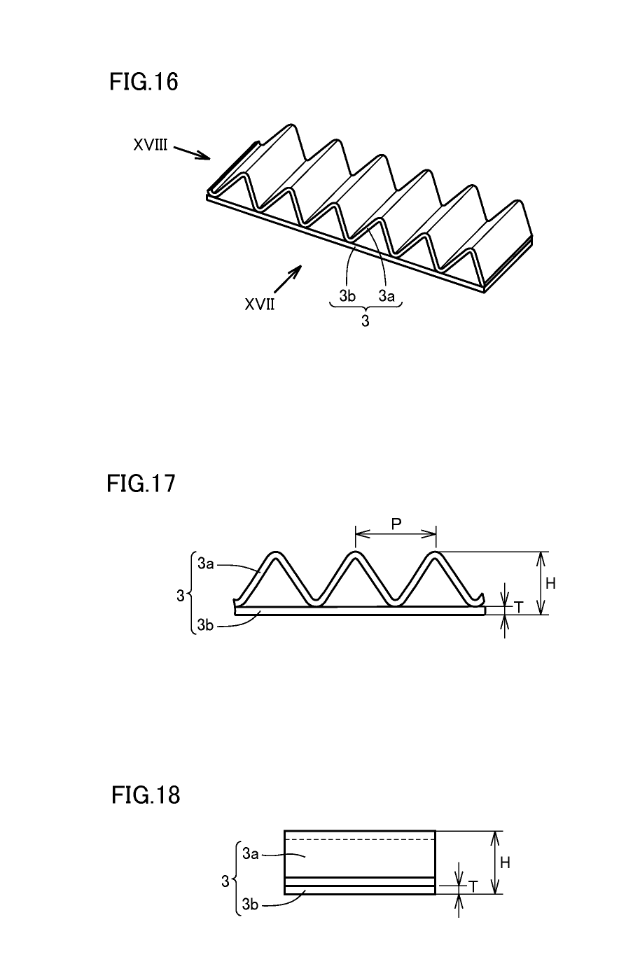

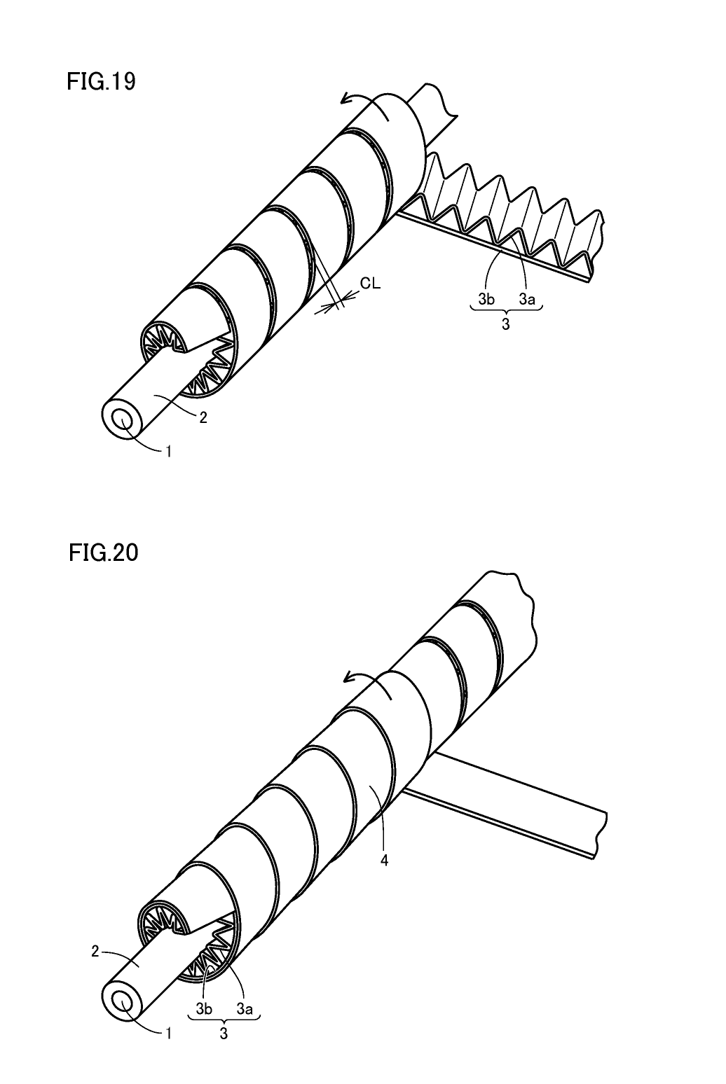

FIG. 16 is a perspective view illustrating the structure of single-face corrugated cardboard according to the third embodiment. FIG. 17 is a side view illustrating a dimensional relation when the single-face corrugated cardboard of FIG. 16 is seen in the direction of arrow XVII. FIG. 18 is a side view illustrating a dimensional relation when the single-face corrugated cardboard of FIG. 16 is seen in the direction of arrow XVIII. FIG. 19 is a perspective view illustrating a state in which the single-face corrugated cardboard is wound on the first insulating paper of the lead wire in the third embodiment. FIG. 20 is a perspective view illustrating a state in which fourth insulating paper is wound on a liner of the single-face corrugated cardboard in the third embodiment.

As illustrated in FIG. 12, lead wire 1 according to this embodiment has an outer shape that winds in a curved form. Lead wire 1 is one that is pulled out from a winding of an oil-filled transformer that is not illustrated. High voltage is applied to lead wire 1.

As illustrated in FIGS. 12 to 15, in this embodiment, first insulating paper 2 is wound around a surface of lead wire 1 (S100). Specifically, first insulating paper 2 having a width substantially equal to the length between opposite ends of lead wire 1 is wound around lead wire 1 a plurality of times, so as to form layers of first insulating paper 2 until a prescribed thickness or greater is achieved. While crepe paper is used as first insulating paper 2 in this embodiment, the material of first insulating paper 2 is not limited to crepe paper, and may be any paper with insulation properties. The surface of lead wire 1 can be protected by winding first insulating paper 2 around lead wire 1.

In this embodiment, the step of winding first insulating paper 2 (S100) is performed; however, where lead wire 1 that has previously been wound with first insulating paper 2 is prepared, it is unnecessary to perform the step of winding first insulating paper 2 (S100).

Next, as illustrated in FIG. 14, first single-face corrugated cardboard 3 made of insulating paper is spirally wound around lead wire 1 wound with first insulating paper 2 (S101).

The structure of first single-face corrugated cardboard 3 will now be described. As illustrated in FIGS. 16 to 18, first single-face corrugated cardboard 3 is made up of a central core 3a obtained by molding pressboard as the second insulating paper into a wave shape in a side view, and a liner 3b made of plate-shaped pressboard as the third insulating paper, central core 3a and liner 3b being adhered to each other with an adhesive. Specifically, liner 3b is affixed to top portions (crests) on one side of central core 3a. Top portions (troughs) on the other side of central core 3a are not confined.

In this embodiment, various portions of first single-face corrugated cardboard 3 have the following sizes. Thickness T of liner 3b is not less than 0.5 mm and not more than 1.0 mm, in order to ensure strength of first single-face corrugated cardboard 3. The height of first single-face corrugated cardboard 3 is not less than 5 mm and not more than 10 mm, in order to ensure an oil clearance size described below. Pitch P between adjacent top portions of waveforms of central core 3a is not less than 15 mm and not more than 30 mm, in consideration of the number of top portions per circumference when winding first single-face corrugated cardboard 3. Width W of first single-face corrugated cardboard 3 is not less than 20 mm and not more than 100 mm, in consideration of the curved winding of lead wire 1.

As illustrated in FIG. 19, as a first winding step, first single-face corrugated cardboard 3 is spirally wound onto first insulating paper 2 of lead wire 1 whose surface is wound with first insulating paper 2, in such a manner that troughs of central core 3a and first insulating paper 2 come into contact with one another.

In this embodiment, in the first winding step, first single-face corrugated cardboard 3 is wound such that a clearance CL is formed between opposite side faces of layers of first single-face corrugated cardboard 3 that are wound and adjacent to each other.

As illustrated in FIG. 13, central core 3a of first single-face corrugated cardboard 3 forms an oil clearance between first insulating paper 2 and liner 3b. Lead wire 1 is disposed within the tank of an oil-filled transformer, and thus, immersed in insulating oil. The insulating oil circulates by convection within the tank, and lead wire 1 is cooled by the insulating oil flowing within the oil clearance formed by central core 3a. A prescribed oil clearance size is ensured to maintain this cooling performance.

As described above, when clearance CL is formed between opposite side faces of layers of first single-face corrugated cardboard 3 that are wound and adjacent to each other, the insulating oil flowing within the oil clearance partially leaks out of the oil clearance through clearance CL.

Part of the insulating oil heated to a relatively high temperature by cooling lead wire 1 while the insulating oil is flowing within the oil clearance has a specific gravity lower than that of the rest of the insulating oil with a relatively low temperature, and hence, is allowed to flow in an upper portion within the oil clearance and also has a reduced viscosity. The part of the insulating oil with a relatively high temperature by cooling lead wire 1 while the insulating oil is flowing within the oil clearance then leaks out of the oil clearance through clearance CL positioned in the upper portion. In this way, the remaining portion of lead wire 1 can be cooled with the insulating oil with a relatively low temperature. Consequently, the cooling efficiency for lead wire 1 can be improved. It is noted that clearance CL may not necessarily be provided.

As illustrated in FIGS. 14 and 20, as a second winding step, fourth insulating paper 4 is spirally wound onto liner 3b of lead wire 1 after the step of first winding step (S102). Specifically, fourth insulating paper 4 having a width substantially equal to width W of first single-face corrugated cardboard 3 is spirally wound a plurality of times such that layers of fourth insulating paper 4 partially overlap with each other on liner 3b of lead wire 1, so as to form layers of fourth insulating paper 4 until a prescribed thickness or greater is achieved.

As illustrated in FIG. 12, opposite ends of fourth insulating paper 4 are affixed onto first insulating paper 2. First single-face corrugated cardboard 3 can be prevented from becoming loose, by winding fourth insulating paper 4 thereon.

While crepe paper is used as fourth insulating paper 4 in this embodiment, the material of fourth insulating paper 4 is not limited to crepe paper, and may be any paper with insulation properties. Moreover, in this embodiment, fourth insulating paper 4 is wound to cover clearance CL. The insulating oil that has leaked out through clearance CL as described above penetrates fourth insulating paper 4 to flow out of the insulation structure of lead wire 1.

The insulation structure of lead wire 1 is formed of first insulating paper 2, first single-face corrugated cardboard 3, and fourth insulating paper 4 described above. With this structure, even where lead wire 1 winds in a curved form and has any of various outer shapes, an insulation structure can be formed by spirally winding each of first single-face corrugated cardboard 3 and fourth insulating paper 4 to conform to the outer shapes of lead wire 1.

It is thus unnecessary to design first single-face corrugated cardboard 3 and fourth insulating paper 4 individually to conform to the outer shapes of lead wire 1. Furthermore, it is easy to spirally wind first single-face corrugated cardboard 3 and fourth insulating paper 4 around lead wire 1 wound with first insulating paper 2. The insulation structure of lead wire 1 according to this embodiment can thus be easily attached to lead wire 1 having any of various outer shapes that winds in a curved form, in a versatile manner.

With the provision of the insulation structure of lead wire 1 described above, the oil clearance formed by central core 3a of first single-face corrugated cardboard 3 can be filled with insulating oil with a low dielectric constant, thus leading to a reduced electric field on the surface of fourth insulating paper 4. Furthermore, as described above, lead wire 1 can be cooled by the insulating oil flowing within the oil clearance.

In a transformer having the above-described insulation structure of lead wire 1, an insulation distance from lead wire 1 can be reduced, thus leading to a reduction in size of the transformer.

While the insulation structure including a single layer of single-face corrugated cardboard is formed in this embodiment, an insulation structure including a plurality of layers of single-face corrugated cardboard may also be formed. An insulation structure of lead wire 1 according to a fourth embodiment with two layers of single-face corrugated cardboard will be described hereinafter.

### Fourth Embodiment

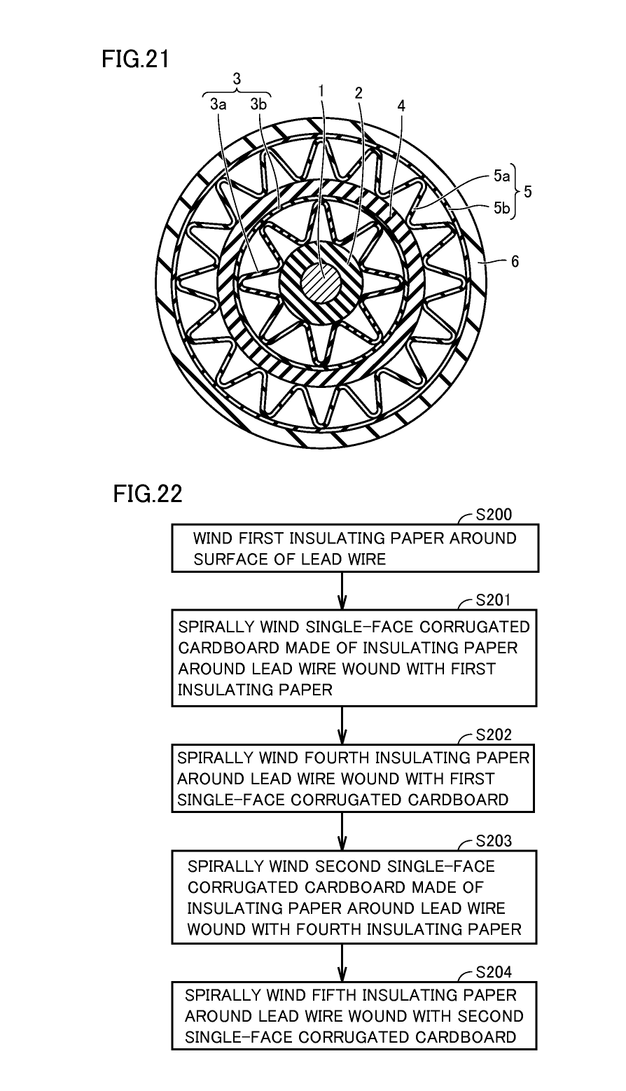

FIG. 21 is a cross-sectional view illustrating the structure of the insulation structure of the lead wire according to the fourth embodiment of the present invention. FIG. 22 is a flowchart illustrating a method for insulating the lead wire according to the fourth embodiment of the present invention. It is noted that FIG. 21 illustrates an actual shape in simplified form, for easy understanding.

As illustrated in FIGS. 21 and 22, in the fourth embodiment of this invention, first insulating paper 2 is wound around a surface of lead wire 1 (S200), as in the third embodiment. In this embodiment, the step of winding first insulating paper 2 (S200) is performed; however, where lead wire 1 that has previously been wound with first insulating paper 2 is prepared, it is unnecessary to perform the step of winding first insulating paper 2 (S200).

Next, as a first winding step, first single-face corrugated cardboard 3 is spirally wound onto first insulating paper 2 of lead wire 1 whose surface is wound with first insulating paper 2, in such a manner that troughs of central core 3a and first insulating paper 2 come into contact with one another. As a second winding step, fourth insulating paper 4 is spirally wound onto liner 3b of lead wire 1 after the step of first winding step (S202).

As a third winding step, second single-face corrugated cardboard 5 having the same structure as that of first single-face corrugated cardboard 3 according to the third embodiment is spirally wound onto fourth insulating paper 4 of lead wire 1 after the second winding step, in such a manner that troughs of central core 5a and fourth insulating paper 4 come into contact with one another (S203).

Next, as a fourth winding step, fifth insulating paper 6 is spirally wound onto liner 5b of second single-face corrugated cardboard 5 of lead wire 1 after the third winding step (S204). Consequently, an insulation structure including two layers of single-face corrugated cardboard can be formed, as illustrated in FIG. 21. While the insulation structure including two layers of single-face corrugated cardboard is formed in this embodiment, the insulation structure may include a plurality of layers of single-face corrugated cardboard, without being limited to two layers.

In the insulation structure of lead wire 1 according to this embodiment, the electric field on the surface of fifth insulating paper 6 can be reduced as compared to the electric field on the surface of fourth insulating paper 4. Therefore, where sufficient insulation performance cannot be obtained with the insulation structure including a single layer of single-face corrugated cardboard as with the insulation structure of lead wire 1 according to the third embodiment, insulation performance can be ensured by providing a plurality of layers of single-face corrugated cardboard as in the insulation structure of lead wire 1 according to this embodiment.

It is noted that the insulation structure of the lead wire according to the third or fourth embodiment may be combined with the insulating sheet according to the first embodiment. An insulation structure of a lead wire including the insulating sheet will be described hereinafter. It is noted that the description of the structure described in the first or third embodiment will not be repeated.

### Fifth Embodiment

The insulation structure of a lead wire according to a fifth embodiment of the present invention includes insulating tape 22 as a first covering insulating layer wound around a surface of lead wire 1, insulating sheet 23 provided on insulating tape 22, and insulating tape 26 as a second covering insulating layer provided on insulating sheet 23. Insulating sheet 23 includes base paper 25 having a prescribed width, and insulating spacers 24 disposed to protrude from base paper 25 at prescribed spacings in a longitudinal direction of base paper 25. Insulating sheet 23 is spirally wound such that insulating tape 22 comes into contact with insulating spacers 24. Insulating tape 26 is spirally wound on insulating spacers 24.

A method for insulating a lead wire according to this embodiment includes a first winding step of spirally winding insulating sheet 23 that includes base paper 25 having a prescribed width and insulating spacers 24 disposed to protrude from base paper 25 at prescribed spacings in the longitudinal direction of base paper 25, onto insulating tape 22 of lead wire 1 whose surface is wound with insulating tape 22, such that insulating spacers 24 and insulating tape 22 come into contact with one another, and a second winding step of spirally winding insulating tape 26 onto base paper 25 of lead wire 1 after the first winding step.

The insulation structure of lead wire 1 is formed of insulating tape 22, insulating spacers 23, and insulating tape 26 described above. With this structure, even where lead wire 1 winds in a curved form and has any of various outer shapes, an insulation structure can be formed by spirally winding each of insulating spacers 24 and insulating paper 26 to conform to the outer shape of lead wire 1.

It is thus unnecessary to design insulating spacers 24 and insulating tape 26 individually to conform to the outer shape of lead wire 1. Furthermore, it is easy to spirally wind insulating spacers 24 and insulating tape 26 onto lead wire 1 wound with insulating tape 22. The insulation structure of lead wire 1 according to this embodiment can thus be easily attached to lead wires 1 having various outer shapes that wind in curved forms, in a versatile manner.

It should be noted that the foregoing embodiments disclosed herein are illustrative in every respect, and do not form a basis of any limitative interpretation. Accordingly, the technical scope of the present invention shall not be interpreted using the foregoing embodiments only, but shall be defined based on the claims. Furthermore, the present invention include any modifications within the scope and meaning equivalent to the terms of the claims.

### REFERENCE SIGNS LIST

1, 14: lead wire, 2: first insulating paper, 3: first single-face corrugated cardboard, 3a: central core, 3b, 5b: liner, 4: fourth insulating paper, 5: second single-face corrugated cardboard, 6: fifth insulating paper, 10: shell-type transformer, 11: iron core, 12: coil, 13: tank, 15: bushing, 21: conductor, 22, 26: insulating tape, 23: insulating sheet, 23b, 33b: edge portion, 24: insulating spacer, 25: base paper, 27: flow path, 29: overlap portion, 33: corrugated board sheet, 34: corrugated board.

1. (canceled)

2. (canceled)

3. (canceled)

4. (canceled)

5. (canceled)

6. An insulation structure for a lead wire comprising:
first insulating paper wound around a surface of a lead wire having a straight portion and a curved portion and immersed in an insulating oil;
first single-face corrugated cardboard formed by affixing a liner made of third insulating paper to a central core made of second insulating paper, said first single-face corrugated cardboard being spirally wound on said first insulating paper such that said central core and said first insulating paper come into contact with each other; and
fourth insulating paper spirally wound on said liner of said first single-face corrugated cardboard and through which said insulating oil can penetrate,
a clearance being formed between opposite side faces of layers of said first single-face corrugated cardboard that are wound continuously from said straight portion to said curved portion and are adjacent to each other, and
said fourth insulating paper being wound to cover said clearance formed from said straight portion to said curved portion.

7. (canceled)

8. An insulation structure for a lead wire according to claim 6, further comprising:
second single-face corrugated cardboard formed by affixing said liner to said central core, said second single-face corrugated cardboard being spirally wound on said fourth insulating paper such that said central core and said fourth insulating paper come into contact with each other; and
fifth insulating paper spirally wound on said liner of said second single-face corrugated cardboard.

9. A transformer comprising the insulation structure for a lead wire according to claim 6.

10. (canceled)

11. A method for insulating a lead wire comprising:
a first winding step of spirally winding single-face corrugated cardboard formed by affixing a liner made of third insulating paper to a central core made of second insulating paper, onto first insulating paper wound around a surface of a lead wire having a straight portion and a curved portion and immersed in an insulating oil, such that said central core and said first insulating paper come into contact with each other; and
a second winding step of spirally winding fourth insulating paper through which said insulating oil can penetrate onto said liner of said lead wire after said first winding step,
in said first winding step, said single-face corrugated cardboard being wound such that a clearance is formed between opposite side faces of layers of said single-face corrugated cardboard that are wound continuously from said straight portion to said curved portion and are adjacent to each other, and
in said second winding step, said fourth insulating paper being wound to cover said clearance formed from said straight portion to said curved portion.

12. (canceled)

13. The method for insulating a lead wire according to claim 11, further comprising:
a third winding step of spirally winding said single-face corrugated cardboard onto said fourth insulating paper of said lead wire after said second winding step, such that said central core and said fourth insulating paper come into contact with each other; and
a fourth winding step of spirally winding fifth insulating paper onto said liner of said lead wire after said third winding step.
